(19) United States
(12) Patent Application Publication
(10) Pub. No.: US 2024/0226871 A9
(43) Pub. Date: Jul. 11, 2024

(54) LOCKING DEVICE, PIPETTING TOOL, AND ASSOCIATED METHOD, ACCESSORY AND INSTALLATION

(71) Applicants: UNIVERSITE DE VERSAILLES-SAINT-QUENTIN-EN-YVELINES, VERSAILLES CEDEX (FR); ASSISTANCE PUBLIQUE - HOPITAUX DE PARIS, Paris (FR); INSTITUT NATIONAL DE LA SANTE ET DE LA RECHERCHE MEDICALE - I.N.S.E.R.M., Paris Cedex 13 (FR)

(72) Inventor: Martin ROTTMAN, LA CELLE SAINT-CLOUD (FR)

(73) Assignees: UNIVERSITE DE VERSAILLES-SAINT-QUENTIN-EN-YVELINES, VERSAILLES CEDEX (FR); ASSISTANCE PUBLIQUE - HOPITAUX DE PARIS, Paris (FR); INSTITUT NATIONAL DE LA SANTE ET DE LA RECHERCHE MEDICALE - I.N.S.E.R.M., Paris Cedex 13 (FR)

(21) Appl. No.: 18/278,870

(22) PCT Filed: Feb. 25, 2022
(86) PCT No.: PCT/EP2022/054791

§ 371 Date: Aug. 25, 2023

(30) Foreign Application Priority Data
Feb. 26, 2021 (FR) 2101899

(51) Int. Cl. B01L 3/02; G01N 35/00; G01N 35/10

(52) U.S. Cl. CPC B01L 3/0217; G01N 35/0099; G01N 35/10; B01L 2200/025; B01L 2200/0668

(57) ABSTRACT

A magnetic locking device for a pipetting tool, the device having a plate that is able to be adapted to the pipetting tool, an accessory being intended to be fastened to a fastening end piece that is supported by the plate and/or intended to be supported by the pipetting tool. The device has at least one lock configured to switch from an active state to a passive state, and vice versa, such that, in the active state, the lock is able to block, in service, particles that are present in the accessory, and such that, in the passive state of the lock, the particles are free to move in the accessory.

The invention relates to a locking device for a pipetting tool.

The invention also relates to a pipetting tool comprising such a locking device.

The invention also relates to a method resorting to such a pipetting tool.

The invention also relates to an installation comprising such a pipetting tool.

The invention also relates to an accessory of such a pipetting tool.

### BACKGROUND OF THE INVENTION

In molecular biology, different techniques are known for extracting and purifying nucleic acids. One of these techniques is based on magnetic separation: the general principle is that nucleic acids, negatively charged, are bond to the magnetic particle surface, the surface of which is positively charged which makes it possible to “hook” one or more types of nucleic acids to the particles and to thus separate the nucleic acids from possible impurities that are present in the initial solutions, in which said nucleic acids were immersed.

There are moreover different methods for bringing magnetic particles into contact with nucleic acids, or separating magnetic particles from nucleic acids within solutions.

A first method consists of placing a magnetic particle suspension in a container, then of moving the container on a magnetic base which will make it possible to block the magnetic particles in the container. Then, one or more solutions are suctioned and/or injected in the container. The container is then again moved to a stirrer so as to release the particles.

Such a method therefore requires a relatively complex and voluminous installation, since it requires several workstations, as well as a significant handling of microplates containing the particles and/or the solutions from one workstation to another.

A second method thus consists of depositing magnetic particles in a first solution containing nucleic acids. The first solution is thus stirred to facilitate the hooking of the nucleic acids to the magnetic particles. Then, the particles are removed from the first solution to be moved into a second solution enabling the washing of the microparticles. The second solution is thus itself stirred, etc. The particles can thus be moved from solution to solution to obtain the purification of the nucleic acids.

Although effective, such a method has proved, there again, to be relatively complex and fastidious.

### Aim of the Invention

An aim of the invention is to offer a solution making it possible to more easily bring magnetic particles into contact with one or more solutions.

### SUMMARY OF THE INVENTION

In view of achieving this aim, the invention proposes a magnetic locking device for a pipetting tool, an accessory being intended to be fastened to a fastening end piece, which is supported by the magnetic locking device and/or which is intended to be supported by the pipetting tool, the device comprising at least one lock configured to pass from an active state to a passive state, and vice versa, such that in the active state, the lock is able to block, in service, particles present in the accessory, and such that in the passive state of the lock, the particles are free to move in the accessory.

In this way, instead of moving the particles from container to container and/or from workstation to workstation to link them with one or more solutions and/or to handle a container containing the suspended particles in a solution to bring the container into contact with magnets, remote from the container, thus immobilising the particles to be able to remove the solution from said container, the invention makes it possible to preserve the particles continuously in the end piece: the particles are thus blocked by the locking device, for the time of ejecting a solution and of sampling a new one from it, before being released again by the disengagement of the locking device, so as to be suspended in the new solution.

The invention thus makes it possible to simply and rapidly bring particles into contact with several solutions.

Advantageously, the invention can easily be implanted in pipetting tools which already exist. According to a particular implementation of the invention, the magnetic locking device is thus supported by a plate, the upper end of which can be fastened to at least one end piece of the pipetting tool, and the lower end of which can receive at least one accessory, such that the locking device is positioned between at least one end piece of the pipetting tool and at least one accessory to form at least one channel: end piece, locking device, accessory.

For the present application, by “solution”, this means a liquid and/or viscous element, and by “suspension”, this means such a solution when particles are soaked in said solution.

Optionally, the lock is arranged at the end piece.

Optionally, the lock is arranged outside of the end piece.

Optionally, the lock comprises at least one tab supporting a magnetic attraction element.

Optionally, a lower end of the tab supports the magnetic attraction element.

Optionally, the tab is movable mounted relative to the end piece between an engaged position in which at least one zone of the tab supporting the magnetic attraction element is at the end piece, and a disengaged position, in which at least said zone is far from the end piece.

Optionally, the tab is movable mounted in the device between its two positions according to a rotation movement.

Optionally, the lock is configured to be able to immobilise, in service, at least two particle clouds relative to the end piece.

Optionally, the lock comprises two tabs, each supporting a magnetic attraction element.

Optionally, the lock comprises at least one permanent magnet, such as a neodymium magnet and/or at least one electromagnet.

Optionally, at least the zones of the two tabs supporting the magnetic attraction elements are arranged on either side of the associated end piece.

The invention also relates to an assembly of a pipetting tool and a device such as mentioned above.

Optionally, the device is integrated with the pipetting tool.

Optionally, the assembly comprises at least one accessory secured to the end piece.

The accessory is, for example, a tip.

Optionally, at least one portion of the internal surface of said accessory and/or at least one portion of the internal surface of the end piece is textured and/or at least one raised element is arranged in the accessory.

Optionally, the accessory and/or the end piece has a housing for receiving at least one part of the lock.

Optionally, the accessory and/or another part of the assembly comprises at least one measuring device.

Optionally, the measuring device comprises a device for optically measuring at least one optical property of the particles and/or of a solution in which the particles are suspended.

Optionally, the measuring device comprises a device for measuring an electrochemical potential.

Optionally, the tool is multichannel.

The invention also relates to a method for linking particles with at least one solution, the method resorting to an assembly such as mentioned above to:
suction the solution when the lock is in its active state and blocks the particles relative to the end piece,
switch the lock into its passive state once the solution is suctioned to leave the particles suspended in the solution that is present in the tool.

The invention also relates to a robotic installation comprising an assembly such as mentioned above.

The invention also relates to an accessory for an assembly such as mentioned above.

The accessory is, for example, a tip.

Optionally, the accessory can comprise at least one housing, such as a flat spot, intended to reduce the distance between the particles and the lock.

This makes it possible to increase the magnetic field, to which the particles are subjected.

The accessory can optionally comprise at least one textured zone and, for example, at least one raised part (the textured zone being intrinsic to the accessory by being formed at a wall of the accessory and/or being formed by an additional element mounted in the accessory).

The raised part makes it possible to improve the mixing capacity of the particles with a suspension that is present in the accessory.

The accessory can optionally comprise at least one surface intended to measure and/or allowing to measure at least one optical property of the particles immobilised by the lock, in particular, the absorbance, the fluorescence and/or the luminescence at any wavelengths, and for example, at short ultraviolet, long ultraviolet, visible, near infrared and far infrared wavelengths.

The accessory can optionally comprise at least one surface intended to measure and/or allowing to measure at least one optical property of a solution contained in the accessory, in particular, the absorbance, the fluorescence and/or the luminescence at any wavelengths, and for example, at short ultraviolet, long ultraviolet, visible, near infrared and far infrared wavelengths.

The accessory can optionally comprise at least one surface intended to measure and/or allowing to measure at least one optical property of a suspension contained in the accessory, in particular, the absorbance, the fluorescence and/or the luminescence at any wavelengths, and for example, at short ultraviolet, long ultraviolet, visible, near infrared and far infrared wavelengths, either in the presence of particles, or in the absence of these particles immobilised beforehand by the lock away from this surface.

The accessory can optionally comprise at least one surface intended to measure and/or allowing to measure at least the electrochemical potential of the particles, for example, by way of at least one electrode.

Other characteristics and advantages of the invention will appear upon reading the following description of a particular, non-limiting embodiment of the invention.

### BRIEF DESCRIPTION OF THE DRAWINGS

The invention will be best understood in the light of the description below in reference to the accompanying schematic figures, among which:

FIG. 1 is a three-dimensional view of a pipetting tool according to a particular embodiment of the invention;

FIG. 2a is a three-dimensional view of a part of the tool illustrated in FIG. 1 when a locking device of the tool illustrated in FIG. 1 is in an active state;

FIG. 2b is a three-dimensional view of a part of the tool illustrated in FIG. 1 when a locking device of the tool illustrated in FIG. 1 is in a passive state;

FIG. 3a schematically illustrates a first step of a particular implementation of a method having resorted to the tool illustrated in FIG. 1;

FIG. 3b schematically illustrates a second step succeeding the first step schematised in FIG. 3a;

FIG. 3c schematically illustrates a third step succeeding the second step schematised in FIG. 3b;

FIG. 3d schematically illustrates a fourth step succeeding the third step schematised in FIG. 3c;

FIG. 3e schematically illustrates a step subsequent to the third step schematised in FIG. 3d.

FIG. 3f schematically illustrates a pipetting tool comprising a locking device supported by a removable plate, according to a second particular embodiment of the invention.

### DETAILED DESCRIPTION OF THE INVENTION

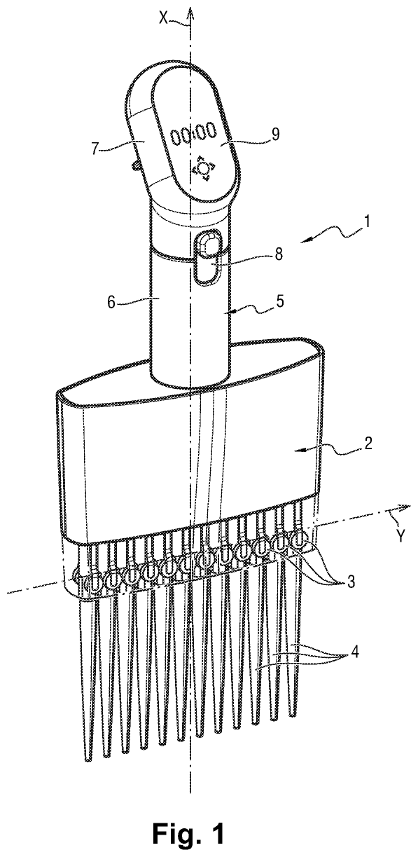

In reference to FIG. 1, the pipetting tool 1 according to a particular embodiment of the invention is, in this case, a pipette.

The tool 1 comprises a body 2 comprising at the bottom a plurality of fastening end pieces 3 (only one part being referenced in this case) and, for example, between 1 and 16 fastening end pieces. Each end piece 3 is shaped such that an accessory 4 (only one part being referenced in this case) can be temporarily fastened to respectively one of said end pieces 3. Typically, the upper end of each accessory 4 is arranged inside one of the end pieces 3 of the tool 1.

The accessory 4 is, for example, a tip. The accessory 4 is, for example, shaped in a cone.

In this way, when the accessories 4 are fastened to the end pieces 3, each accessory 4 forms, with the associated end piece 3, a particular channel. The tool 1 thus comprises, in this case, between 1 and 16 channels, and preferably, between 2 and 16 channels.

The tool 1 is therefore a multichannel pipette.

At least at their temporary securings, the end pieces 3 and the accessories 4 have a circular radial cross-section.

The tool 1 is moreover shaped, such that each channel extends rectilinearly in directions which are all parallel to one another, and to a first general axis X.

Moreover, the tool 1 is shaped, such that the different channels extend side-by-side, forming one single row of channels. The row thus itself extends along a second axis Y.

The tool 1 is shaped such that the second axis Y is, in this case, orthogonal to the first axis X.

Moreover, the body 2 is extended in the upper part of a handle 5 of the tool. In service, an operator can thus manually move the tool 1 from a point A to a point B easily, thanks to said handle 5.

The tool 1 is therefore a manual pipetting tool.

According to a particular embodiment, the handle 5 comprises a gripping portion 6 which extends substantially rectilinearly along the first axis X and which is extended upwards by a head 7.

Optionally, the gripping portion 6 is secured, at a first end, to an upper face of the body 2 and at a second end, to the head 7.

The gripping portion 6 is, in this case, a rod.

The gripping portion 6 is, preferably, of radial cross-section without a ridge. The gripping portion 6 is thus of circular, elliptic, etc. radial cross-section.

This makes it possible to make the tool 1 ergonomic for the operator who therefore handles the tool 1 by having their palm surrounding the gripping portion 6.

The head 7 is itself preferably arranged so as to extend in a direction that is inclined vis-à-vis the first X.

Moreover, the tool 1 is shaped to make it possible to suction a fluid in its different channels, to hold said fluid in said channels and to release said fluid from said channels, and this, according to the commands of the operator.

To this end, a pumping module (which cannot be seen, in this case) is optionally arranged in the handle 5 and connected to the different end pieces 3 (and therefore to the different channels when the accessories 4 are in place in the tool 1). With such a module being well-known from the prior art, it will not be detailed further.

The tool 1 is therefore a piston pipette.

As indicated above, the operator must be able to control the pumping module. To this end, the tool 1 comprises at least one interface for driving the pumping module.

Optionally, a first driving interface 8 is arranged on the gripping portion 6. The first interface 8 is, for example, a control button.

The first interface 8 is, preferably, arranged in the top of the gripping portion 6.

This makes the tool 1 more ergonomic for the operator who can thus surround the gripping portion 6 with their palm and actuate the first interface 8, when they so wish, with their thumb.

The first interface 8 is preferably arranged in a plane parallel to that defined by the axes X and Y.

The tool 1 is thus configured, such that when the operator presses on the first interface 8, this leads to the suctioning of the fluid simultaneously in the different channels and when the operator presses on the first interface 8 again, this leads to a simultaneous expulsion of the fluid from the different channels.

Optionally, a second driving interface 9 is arranged at the head 7. The second interface 9 is, for example, a screen.

The second interface 9 thus makes it possible to provide different information to the operator (like, for example, an indication of whether the channels are filled or empty, in what quantities, an indication of the time, of the battery level of the tool 1, etc.).

Preferably, the tool 1 is shaped such that, in service, the first interface 8 faces the user and that the head 7 is inclined towards the rear of the tool 1 (in the direction opposite the first interface 8).

This facilitates the reading of the second interface 9 by the operator.

According to a particular embodiment, the tool 1 comprises a control member (which cannot be seen, in this case) of said tool and, in particular, of the pumping module. The control member is, for example, a computer, a microcomputer, etc. The control member is arranged in the body 2 and/or the handle 5.

Thus, even if it is the operator who chooses to suction or to release the fluid into the channels, it is strictly speaking the control member which controls the pumping module to ensure that the command from the operator is actually performed.

This makes it possible to work more accurately.

Preferably, at least one of the driving interfaces 8, 9 makes it possible for the operator to communicate with the control member.

In the present case, the second interface 9 is tactile and makes it possible for the operator to communicate with the control member.

In particular, the operator can thus indicate to the control member, the quantity of solution to suction into the different channels.

Preferably, the tool 1 incorporates a module for electrically powering the tool, such as a battery.

This makes the tool 1 more autonomous.

Alternatively, or complementarily, the tool 1 can operate by being connected to the mains.

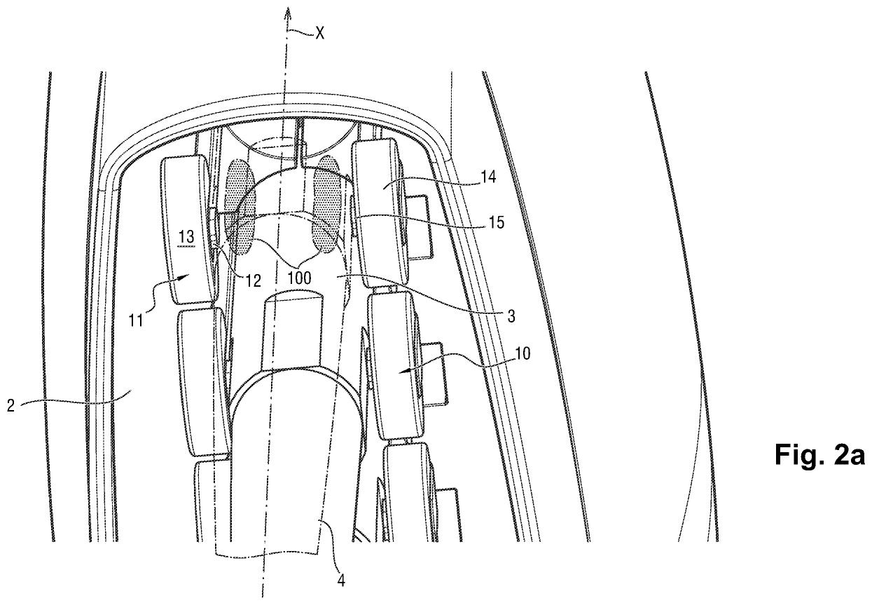

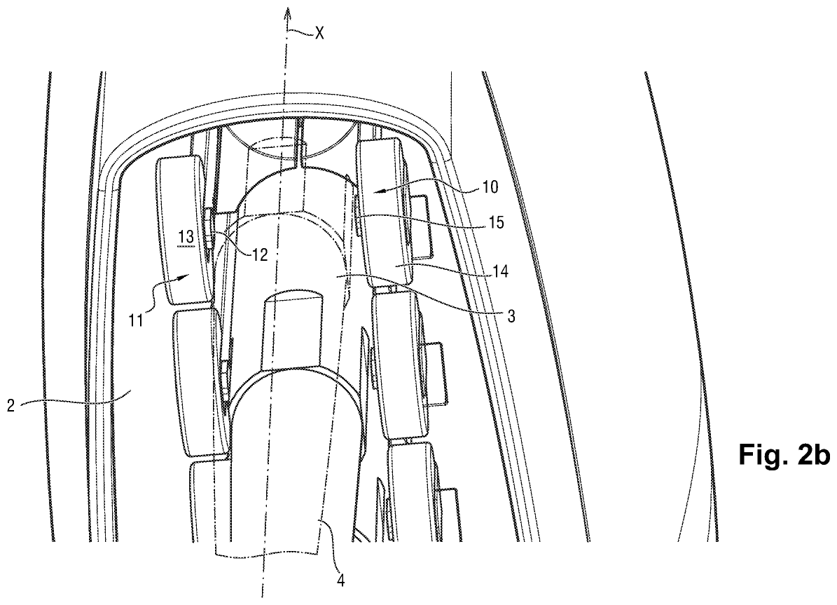

According to the invention, and as can be seen better in FIGS. 2a and 2b, the tool 1 comprises a device for magnetically locking particles intended to be arranged in the channels.

The particles are, in a manner known per se, magnetic particles such as magnetic and/or superparamagnetic metal particles.

It is reminded that a “superparamagnetic” particle is a particle which behaves like a magnet under the influence of an external magnetic field, but which immediately loses its magnetic properties as soon as said external magnetic field is stopped.

The magnetic locking device comprises, in this case, a lock 10 associated with each end piece 3 (and therefore, with each channel when the accessories 4 are in place).

Each lock 10 is arranged at the associated end piece 3 and configured to pass from an active state to a passive state, and vice versa, such that:
in the active state, the lock 10 blocks, in service, at least one first particle cloud 100 that is present in the accessory 4 associated with the end piece 3 in question, and
in the passive state, the at least one particle cloud 100 is free to move in the accessory 4.

It is indeed reminded, that the particles are very small. A particle thus generally has a diameter of between nanometres and 100 micrometres and preferably, between 300 nanometres and 10 micrometres. Microparticles, i.e. particles of at least 100 nanometres and preferably of between 100 nanometres and 100 micrometres can, for example, be chosen.

A very large multiplicity of particles is therefore present, in service, in each accessory 4. It is thus possible to have thousands, even millions of particles in the accessory 4.

Consequently, each lock does therefore not attract only one single particle, but the whole particle cloud at once.

With the different locks 10 all being identical to one another, the description below of one of them is also applicable to the other locks 10.

The lock 10 is preferably arranged outside of the associated end piece 3 and therefore, outside of the possible associated accessory 4.

According to a particular embodiment, the lock 10 comprises at least one tab 11 supporting a magnetic attraction element 12.

The magnetic attraction element 12 is, for example, a magnet. The magnet is, for example, a permanent magnet. The magnet is, for example, a neodymium magnet.

The tab 11 is optionally shaped, so as to have a free lower end 13 supporting the magnetic attraction element 12.

Preferably, said lower end 13 is flat and thus has two main flat faces.

According to a particular embodiment, the magnetic attraction element 12 is arranged in the tab 11 so as to laterally project from it: typically, the magnetic attraction element 12 is arranged in the tab 11 so as to externally project from one of the two main flat faces of the lower end 13 (and more specifically, from the flat face facing the associated end piece 3).

Preferably, the tab 11 is movably mounted relative to the end piece 3, and outside of the end piece 3, between:
an engaged position, in which at least the lower end 13 of the tab 11 is at the end piece 3 (as illustrated in FIG. 2a), and
a disengaged position, in which at least the lower end 13 of the tab 11 is far from the end piece 3 (as illustrated in FIG. 2b).

In the engaged position of the tab 11, the magnetic attraction element 12 is thus at the end piece 3. Preferably, the magnetic attraction element 12 is in the immediate proximity of the end piece 3, even bears against an external wall of the end piece 3. In the engaged position of the tab, the magnetic attraction element 12 can therefore block at least one particle cloud 100 which could be present inside the channel in question by holding it in position against the internal wall of the end piece 3 and/or of the associated accessory 4.

The lock 10 is thus in its active state.

In the disengaged position of the tab 11, the magnetic attraction element 12 is far from the end piece 4 so as to no longer be able to attract and flatten the particle cloud 100 against the internal wall of the end piece 3 and/or of the associated accessory 4.

The lock 10 is thus in its passive state.

It is thus seen, that the lock 10 advantageously makes it possible to block the particle cloud 100 in position in the channel, without the lock 10 itself being in contact with the inside of said channel.

Optionally, the second interface 9 provides an indication to the user of the state in which the lock 10 is.

Typically, the lock 10 comprises a drive mechanism (which cannot be seen, in this case) which is connected to an upper end of the tab 11 to enable the movement of the tab 11 between these two positions.

Preferably, the tab 11 is movable mounted in the tool 1 between these two positions according to a rotation movement which is, in this case, of axis parallel to the second axis Y.

In the engaged position of the tab 11, preferably, at least the lower end of the tab 11 extends rectilinearly parallel to the axis X.

In the disengaged position of the tab 11, preferably, at least the lower end of the tab 11 extends inclined vis-à-vis said axis X.

Preferably, the control member is configured to control the actuation mechanism, and thus, the movement of the tab 11 between its engaged position and its disengaged position (and therefore the switching of the corresponding lock 10 from its active state to its passive state).

Optionally, this can be the operator who commands the switching of the tab 11 from one position to another (i.e. the switching of the lock 10 from an active state to a passive state), via one or more interfaces, or this can be performed automatically by the control member.

According to a particular embodiment, each lock 10 is configured to be able to immobilise in position, relative to the associated end piece 3, at least two magnetic particle clouds 100.

To this end, each lock 10 comprises, in this case, a second tab 14 also supporting a magnetic attraction element 15. With the two tabs 11, 14 of a lock 10 being identical to one another, the description which has just been made of the first tab 11 is therefore also applicable to the second tab 14.

In the present case, each magnetic attraction element 12, 15 is of shape and of dimensions that are able to only hold one single particle cloud 100 in position against the internal wall of the end piece 3 and/or of the associated accessory 4. Thus, each lock 10 is, in this case, configured to be able to immobilise in position, relative to the associated end piece 3, strictly two particle clouds 100.

At least the lower ends of the two tabs 11, 14 are optionally arranged on either side of the associated end piece 3. Thus, said lower ends are arranged radially opposite.

In this way, in the engaged position of the two tabs 11, 14, the two lower ends, and more specifically, their two magnets, face one another on either side of the channel in question. The two lower ends thus extend parallel to one another and to the first axis X. Furthermore, the two magnets are substantially at the same height (the height being considered along the first axis X).

In their disengaged position, the two lower ends, and more specifically, the two magnetic attraction elements 12, 15, are inclined against one another and to the first axis X by being away more and more from one another while getting closer to their free edges.

Preferably, the drive mechanism of the lock 10 is the same for the two tabs 11, 14. The actuation mechanism comprises, for example, clamping means making it possible to move the two upper ends of the two tabs 11, 15 closer or farther away, and consequently, respectively move the corresponding lower ends farther away or closer.

The two tabs 11, 15 are therefore moved simultaneously to be together in an engaged position or together in a disengaged position.

In the present case, the tool 1 comprises, in this case, as many drive mechanisms as locks 10. According to a particular embodiment, the tool 1 is moreover shaped such that all the locks 10 are actuated simultaneously.

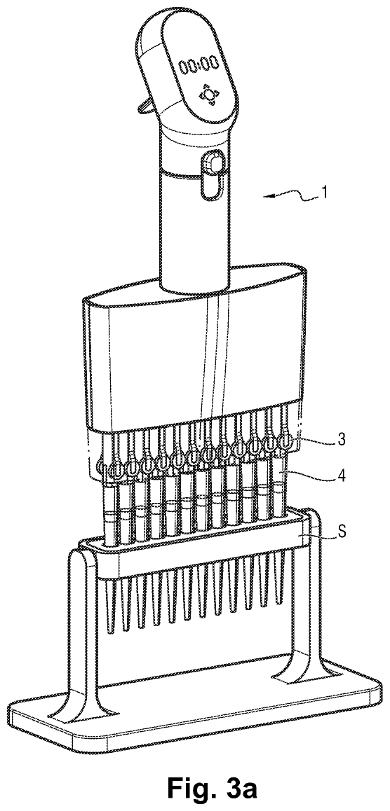

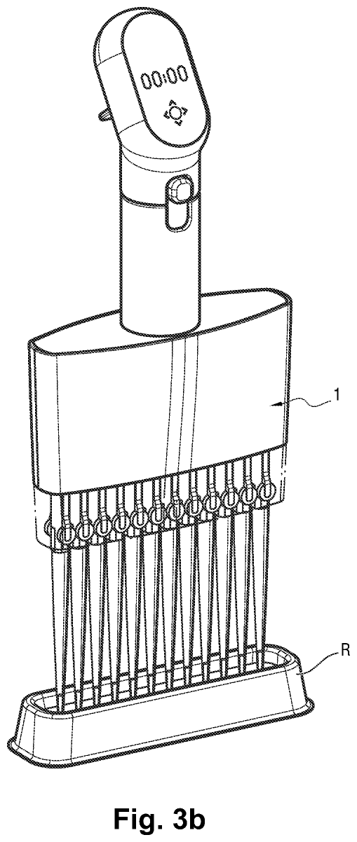

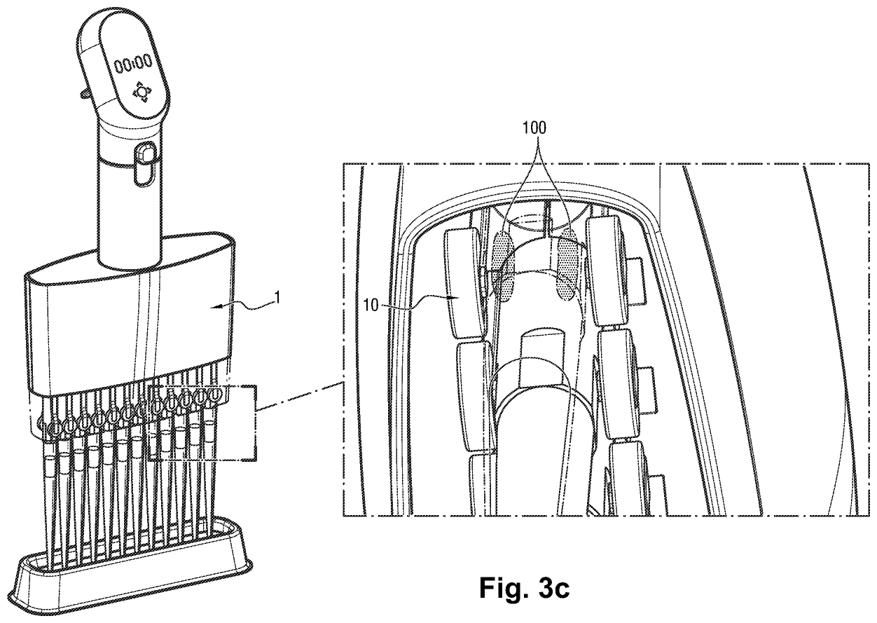

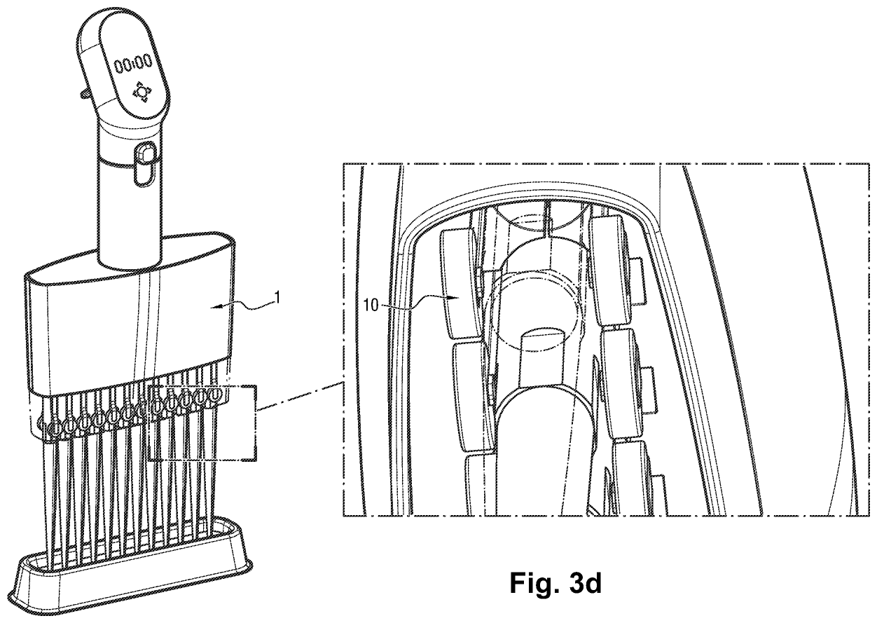

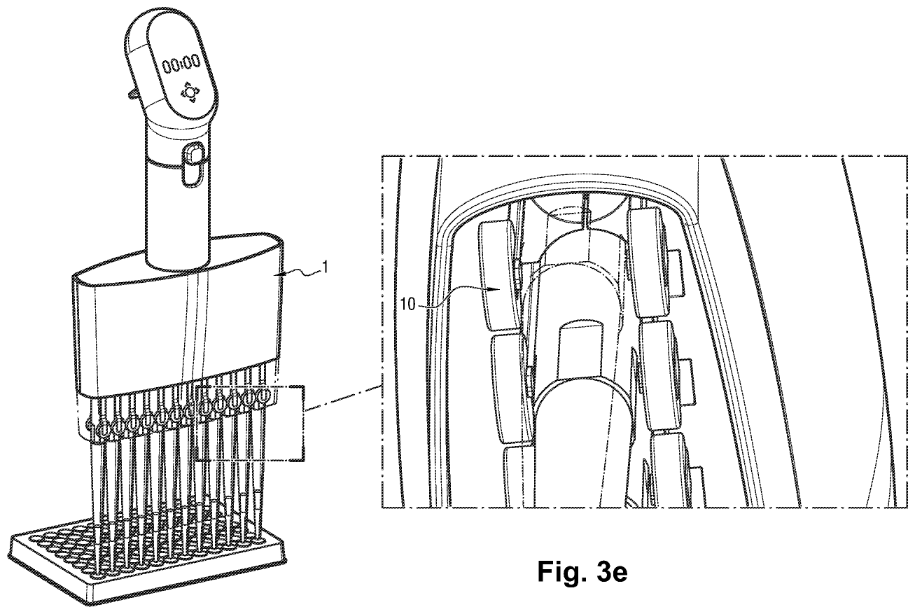

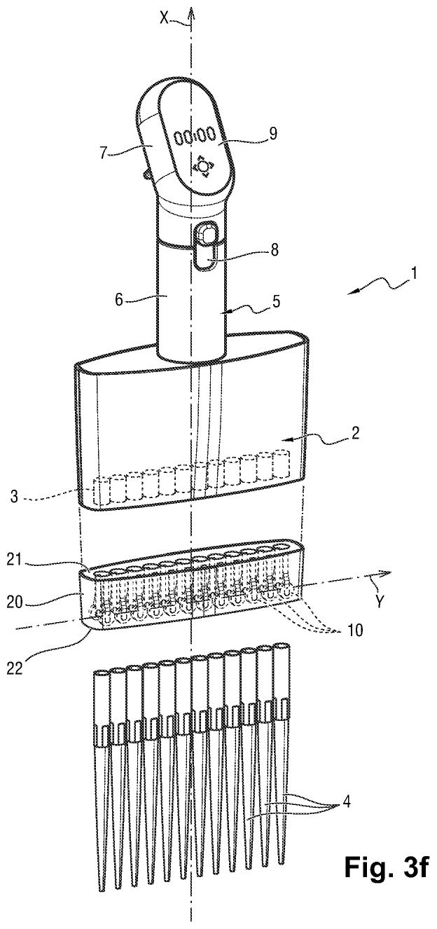

In reference to FIGS. 3a to 3e, a particular implementation of the invention will now be described.

As can be seen in FIG. 3a, the tool 1 is in the initial state with no accessory. Accessories 4 are thus arranged in a row on a support S and the tool 1 is positioned in vertical alignment with said support S to secure an accessory 4 to each end piece 3 of the tool 1.

Such a step is well-known from the prior art and will not be detailed, in this case.

In reference to FIG. 3b, a solution comprising suspended magnetic particles is sampled with the tool 1, the suspension being placed in a container R which can be any container.

In reference to FIG. 3c, the locking device is activated (the locks 10 are in their active state). The suspension that is present in the channels is thus stirred, such that the particles pass in front of the locks 10 and can thus be fastened at their levels under their magnetic actions. This stirring can be manual, but is preferably done automatically. For example, an operator can cause this stirring by commanding the pumping module, which will make it possible to move the suspension in the channels, without however said suspension being released outside of the channels (this being possible, since the suspension volume suctioned is known, which makes it possible to determine what pressure can be exerted by the pumping module to not cause the expulsion of the suspension). Preferably, at least one sweeping (i.e. at least one movement from top to bottom) of the suspension is ensured.

Then, the solution is actually ejected by the tool 1: thanks to the different locks 10, two particle clouds 100 per channel are however held in place, despite the removal of the solution.

In reference to FIG. 3d, a first solution, sometimes also called “reagent” is then removed, which is liquid, in this case. The locking device is then deactivated (the locks 10 are in their passive state): the particles which were held against the internal wall of the associated channel can thus circulate freely in the first solution and thus be filled with one or more components such as, for example (and in a non-limiting manner), one or more nucleic acids.

In order to improve the movement of the particles 100 in the first solution, the suspension that is present in the channels can be stirred. This stirring can be manual, but is preferably done automatically. For example, an operator can cause this stirring by commanding the pumping module, which will make it possible to move the suspension in the channels, without however said suspension being released outside of the channels (this being possible, since the suspension volume suctioned is known, which makes it possible to determine what pressure can be exerted by the pumping module to not cause the expulsion of the suspension). Preferably, at least one sweeping (i.e. at least one movement from top to bottom) of the suspension is ensured.

Preferably, the accessories 4 and/or the end pieces 3 are shaped to have at least, on one portion of their internal surface (i.e. the surface which is in contact with the particles), a textured aspect favouring the movement of the suspension in said accessories 4 and thus improving the capacity of mixing particles with said first solution (and the subsequent solutions encountered). For example, said portion comprises raised elements, such as blades and/or ribs.

Then, according to a step N, the locking device is again activated and the suspension that is present in the channels is thus stirred, such that the particles pass in front of the locks 10 and can thus be fastened at their levels under their magnetic actions. Then, the first solution is ejected by the tool 1: thanks to the different locks 10, the two particle clouds 100 per channel are however held in place.

A second solution is then removed, according to a step N+1. The locking device is then deactivated: the particle clouds 100 which were held against the internal wall of the associated channel can thus circulate freely in the second solution and be filled with one or more components, such as, for example (and in a non-limiting manner), one or more nucleic acids, which are identical or different from those that are present in the first solution.

The steps N and N+1 are then repeated as often as the operator so desires.

Then, the last solution used is ejected, by keeping the particle clouds 100 blocked in the channels.

Then, a neutral solution is removed with the tool 1, then the locking device is deactivated.

In reference to FIG. 3e, the neutral suspension which therefore contains the particles is then ejected into a support, since the locking device is deactivated at the time of ejecting the particles.

The tool 1 thus, simply and rapidly makes it possible to bring the particles 100 into contact with different solutions.

Advantageously, the tool 1 can be used with any type of particles 100 which already exist on the market.

Moreover, the magnetic locking device can be integrated with any type of pipetting tool already existing on the market. Thus, according to a particular embodiment of the invention and in reference to FIG. 3f, the magnetic locking device, the subject matter of the invention, is supported by a plate 20, the upper end 21 of which can be complementarily fastened to at least one end piece 3 of the pipetting tool 1, and the lower end 22 of which is shaped to receive at least one accessory 4, such that the plate supporting the locking device is positioned between at least one end piece of the pipetting tool and at least one accessory to form at least one channel: end piece, plate supporting the locking device, accessory. In this way, a magnetic field can be applied to the plate 20 and/or to the accessory 4 thanks to the addition of the plate 20. Furthermore, a pumping module already in place in the existing pipetting tool is advantageously benefited from, to suction and/or eject and/or move a solution in the accessory. According to this embodiment, the locking device is therefore removable and can be fastened, or not, to the pipetting tool according to the use of the time. It is specified that the plate and the pipetting tool are provided with securing means, which, when they are associated, enable an operation of the pipetting tool similar to the operation of the pipetting tool without the locking device. Preferably, the plate comprises means for electrically and electronically connecting to the pipetting tool, thus enabling the user to control the locking device directly by way of the first interface 8 and/or of the second interface 9.

Naturally, the invention is not limited to the embodiment described and variants of embodiments can be applied without moving away from the scope of the invention such as defined by the claims.

In particular, the locking device can be used in numerous applications other than the extraction and/or the purification of nucleic acids. The locking device can thus be used for any bringing into contact of particles with one or more solutions. Generally, any operation requiring the bringing into contact with particle surfaces with solutions can be implemented by the invention. As a nonlimiting example, the invention can thus be used in a scope of extracting and/or purifying proteins, in a scope of implementation of immuno-enzyme tests, etc.

Although, in this case, the pipetting tool is a multichannel pipette, the pipetting tool can of another type and be, for example, a single-channel pipette, a single-channel or multichannel micropipette.

Furthermore, although, in this case, the tool is a manual pipetting tool, i.e. intended to be handled by a human operator, the tool can be a robotic pipetting tool, i.e. intended to be handled by a robot. The pipetting tool can thus be incorporated in a robotic installation comprising one or more workstations, the pipetting tool being movable inside said installation.

Although, in this case, the fluid is suctioned or released simultaneously in the different channels, the tool can be arranged, such that the fluid can be suctioned or released independently from one channel to another. An operator can thus choose which channels must suction a fluid and/or which channels must release a fluid.

In the same way, although, in this case, the different locks of the device are all actuated or deactivated simultaneously, the locking device can be arranged, such that the locks can be actuated/deactivated independently. An operator can thus choose in which channels the particles must be stationary vis-à-vis the channel in which they are located or, on the contrary, movable.

Although, in this case, the locks are located at the end pieces, the locks can be arranged otherwise, and for example, strictly at the accessories.

Within one same locking device, the locks can be different from one another. Each lock can hold in place, a number of particle clouds that is different from what has been indicated.

Although, in this case, the lock is totally arranged outside of the channel and of the end piece, the lock can be arranged partially or totally inside the channel and/or the end piece.

Each lock can comprise a number of tabs that is different from what has been indicated, and for example, one single tab. One same tab can support at least two magnetic attraction elements for the temporary binding of two particle clouds in the end piece.

The at least one tab can be movably mounted in the body according to a movement other than what has been indicated, and for example, a translation movement. The tab can also be movable in the body according to a rotation movement of axis that is different from the second axis Y. For example, the tab can be rotatably mounted on itself (for example, about an axis orthogonal to the first axis X and to the second axis Y) in the manner of a wheel thus making it possible to move away from or closer to the magnetic attraction element of the channel in question.

The drive mechanism can consequently comprise one or more motors, one or more worm screws, one or more linkage systems, such that the tab describes the targeted movement. The drive mechanism can be at least partially common to all of the locks according to whether the locks are sought to be independent or not.

The lock can, naturally, be different from what has been described.

For example, instead of a magnetic attraction element that is moved closer or farther away, a magnetic attraction element can be had that is concealed to switch the lock from one state to another. The magnetic attraction element can be concealed directly by a removable cover or indirectly, for example, by supporting the magnetic attraction element by a face of a support, and making the support pivot between two positions, according to whether the magnetic attraction element is sought to be facing the channel (active state of the lock) or to be turning back from the channel (passive state of the lock).

Moreover, the lock can switch from its active state to its passive state, other than by a movement within said lock: the lock can thus be configured to switch from its active state to its passive state by powering or cutting off power to said lock. For example, the lock can comprise an electromagnet which, according to whether it is powered or not, makes it possible to block, in position or not, at least one particle cloud in the channel in question.

Although, in this case, the accessories are disposable elements intended to only be temporarily secured to the end piece, said accessories cannot be disposable elements. Alternatively or complementarily, the accessories can thus be in one piece with the end pieces and/or remain rigidly fastened to the rest of the tool and/or of the locking device between two uses.

At least one of the accessories and/or at least one of the end pieces can be different from what has been indicated. For example, at least one of the accessories and/or at least one of the end pieces can be shaped to be able to be arranged closest to the lock. At least one of the accessories and/or at least one of the end pieces can thus, for example, have a housing (such as a flat spot) for receiving the lock. This will make it possible to reduce the distance between the particles that are present in the associated channel and the lock, and thus increase the magnetic forces to which the particles are subjected.

Although, in this case, at least one portion of the internal surface of the accessory and/or at least one portion of the internal surface of the end piece is textured, the accessory and/or the end piece can otherwise be shaped, in order to favour the movement of the suspension in the accessory and/or the end piece. For example, the accessory and/or the end piece can be provided with an element arranged in said accessory and/or said end piece, such as, for example, an element shaped in a screw or having blades or any other type of static mixer.

At least one of the accessories and/or the locking device and/or the tool and/or the robotic installation can comprise at least one measuring device, configured to
measure at least one optical property of the particles that are present in the associated channel from among absorbance, fluorescence, luminescence, etc. for all waves, whether in short ultraviolet waves, long ultraviolet waves, visible waves, near infrared waves, far infrared waves, etc. (preferably, this measurement being taken when the particles are immovable in the associated channel via the lock); and/or
measure at least one optical property of a solution (liquid, for example) that is present in the associated channel, from among absorbance, fluorescence, luminescence, etc. for any wave, whether in short ultraviolet waves, long ultraviolet waves, visible waves, near infrared waves, far infrared waves, etc. (this measurement being able to be taken when particles are suspended in the solution and/or when the particles are immovable in the solution under the action of the lock, the measurement being taken outside of the particle clouds); and/or
measure at least one chemical property of the particles and/or a solution (for example, liquid) that is present in the associated channel, such as an electrochemical potential.

The measuring device can thus comprise an optical sensor, one or more electrodes, etc.

1. A magnetic locking device for a pipetting tool, said pipetting tool comprising:
at least one end piece to which an accessory is temporarily fastened to form a channel,
at least one locking device, said locking device comprising at least one lock arranged at the channel and configured to switch from an active state to a passive state, and vice versa, such as in the active state, the lock is able to block, inservice, the particles that are present in the channel and such that, in the passive state of the lock, the particles are free to move in the channel.

2. The device according to claim 1, wherein the locking device is supported by a plate, said plate being removably fastened by its upper end to at least one end piece of the pipetting tool and able to receive at least one accessory at its lower end.

3. The device according to claim 1, wherein the lock is arranged outside of the end piece.

4. The device according to claim 1, wherein the lock comprises at least one tab supporting a magnetic attraction element.

5. The device according to claim 4, wherein a lower end of the tab supports the magnetic attraction element.

6. The device according to claim 4, wherein the tab is movably mounted relative to the end piece between an engaged position in which at least one zone of the tab supporting the magnetic attraction element is at the end piece and a disengaged position in which at least said zone is far from the end piece.

7. The device according to claim 6, wherein the tab is movably mounted in the device between its two positions according to a rotation movement.

8. The device according to claim 1, wherein the lock is configured to be able to immobilise, in service, at least two particle clouds relative to the end piece.

9. The device according to claim 8, wherein the lock comprises two tabs each supporting a magnetic attraction element.

10. Device according to claim 9, wherein at least zones of the two tabs supporting the magnetic attraction elements are arranged on either side of the associated end piece.

11. The device according to claim 1, wherein the lock comprises at least one permanent magnet and/or one electromagnet.

12. An assembly of the device according to claim 1 and a pipetting tool.

13. The assembly according to claim 12, wherein the locking device is supported by the pipetting tool.

14. The assembly according to claim 12, comprising at least one accessory secured to the end piece.

15. The assembly according to claim 14, wherein at least one portion of the internal surface of the accessory and/or at least one portion of the internal surface of the end piece is textured and/or at least one raised element is arranged in the accessory and/or the end piece.

16. The assembly according to claim 14, wherein the accessory and/or the end piece has a housing for receiving at least one part of the lock.

17. The assembly according to claim 12, comprising at least one measuring device.

18. The assembly according to claim 17, wherein the measuring device comprises a device for optically measuring at least one optical property of the particles and/or a solution in which the particles are suspended.

19. The assembly according to claim 18, wherein the measuring device is a device for measuring an electro-chemical potential.

20. The assembly according to claim 12, wherein the tool is multichannel.

21. A robotic installation comprising the assembly according to claim 12.

22. A method for linking particles with at least one solution, the method resorting to the assembly according to claim 12 to:
suction the solution when the lock is in its active state and blocks the particles relative to the end piece,
switch the lock into its passive state once the solution is suctioned to leave the particles suspended in the solution that is present in the tool.

23. An accessory for the assembly according to claim 12, wherein the accessory is secured to the locking device and/or to the body of the tool.
